(19) United States
(12) Patent Application Publication
(10) Pub. No.: US 2025/0306373 A1
(43) Pub. Date: Oct. 2, 2025

(54) MULTIPLEXING IMAGE LIGHT GUIDE WITH SPLIT INPUT AND OPTICAL POWER

(71) Applicant: Vuzix Corporation, West Henrietta, NY (US)

(72) Inventors: Robert J. Schultz, Victor, NY (US); Marek W. Kowarz, Henrietta, NY (US)

(21) Appl. No.: 18/861,650

(22) PCT Filed: Jun. 20, 2023
(86) PCT No.: PCT/US2023/068721

§ 371 Date: Oct. 30, 2024

Related U.S. Application Data
(60) Provisional application No. 63/367,337, filed on Jun. 30, 2022.

(51) Int. Cl. G02B 27/01

(52) U.S. Cl. CPC G02B 27/0172; G02B 2027/0112; G02B 2027/0123

(57) ABSTRACT

An image light guide, including a substrate operable to propagate image-bearing light beams of a first wavelength range and a second wavelength range, an in-coupling diffractive optic including a first input region and a second input region, the first input region operable to couple image-bearing light of the first wavelength range into the image light guide and the second input region operable to couple image-bearing light of the second wavelength range into the image light guide, and an out-coupling diffractive optic including a first set of diffractive features and a second set of diffractive features, wherein the first set of diffractive features and the second set of diffractive features at least partially overlap within the out-coupling diffractive optic, wherein the first and second set of diffractive features introduce an optical power to change a focusing distance of the first wavelength range and the second wavelength range of image-bearing light beams.

### CROSS-REFERENCE TO RELATED APPLICATIONS

The present application is the U.S. National Stage Application pursuant to 35 U.S.C. § 371 of International Patent Application No. PCT/US23/68721, filed on Jun. 20, 2023, which application claims the benefit under Articles 4 and 8 of the Stockholm Act of the Paris Convention for the protection of Industrial Property of U.S. Patent Application No. 63/367,337, filed on Jun. 30, 2022, which applications are incorporated by reference in their entireties.

### TECHNICAL FIELD

The present disclosure generally relates to electronic displays, and more particularly, to displays utilizing image light guides with diffractive optics to convey image-bearing light to a viewer.

### BACKGROUND

Head-Mounted Displays (HMDs) are being developed for a range of diverse uses, including military, commercial, industrial, fire-fighting, and entertainment applications. For many of these applications, there is particular value in forming a virtual color image that can be visually superimposed over the real-world image that lies in the field of view of the HMD user. Optically transparent flat parallel plate waveguides, also called planar waveguides, convey image-bearing light generated by a color projector system to the HMD user. The planar waveguides convey the image-bearing light in a narrow space to direct the virtual image to the HMD user's pupil and enable the superposition of the virtual image over the real-world image that lies in the field of view of the HMD user.

In such conventional imaging light guides, collimated, relatively angularly encoded light beams from a polychromatic or monochromatic image projector source are coupled into an optically transparent planar waveguide by an input coupling optic, such as an in-coupling diffractive optic, which can be mounted or formed on a surface of the parallel plate planar waveguide or disposed within the waveguide. Such diffractive optics can be formed as diffraction gratings, holographic optical elements, or in other known ways. For example, the diffraction grating can be formed as a surface relief grating. After propagating along the planar waveguide, the diffracted color image-bearing light can be directed back out of the planar waveguide by a similar output grating, which may be arranged to provide pupil expansion along one or more dimensions of the virtual image. In addition, one or more diffractive turning gratings may be positioned along the waveguide optically between the input and output gratings to provide pupil expansion in one or more dimensions of the virtual image. The image-bearing light output from the parallel plate planar waveguide provides an expanded eyebox for the viewer.

A HMID system may consist of at least one image conveying waveguide for conveying virtual image-encoded light to the left eye of the viewer and at least one image conveying waveguide for conveying virtual image-encoded light to the right eye of the viewer, thus enabling stereo images to the viewer.

Current systems for virtual image reconstruction require multiple waveguides, for example, a waveguide stack, where one waveguide is utilized for each wavelength range of light. For example, a first waveguide of the waveguide stack may be used to convey light in the red wavelength range, and a second waveguide of the waveguide stack may be used to convey light in the blue wavelength range. The use of multiple waveguides increases costs as well as the potential for manufacturing defects and ingress of pollutants (e.g., dust particles, moisture, etc.). Additionally, while it is possible to overlap sets of out-coupling diffractive optic gratings to outcouple light of different wavelength ranges within the same waveguide using linear gratings, such arrangement while adding optical power adds additional complexity.

### SUMMARY

The present disclosure is directed to one or more exemplary embodiments of an image light guide.

The image light guide can include a substrate operable to propagate image-bearing light beams of a first wavelength range and a second wavelength range, an in-coupling diffractive optic comprising a first input region and a second input region, the first input region operable to couple image-bearing light of the first wavelength range into the image light guide and the second input region operable to couple image-bearing light of the second wavelength range into the image light guide, and an out-coupling diffractive optic comprising a first set of diffractive features and a second set of diffractive features, wherein the first set of diffractive features and the second set of diffractive features at least partially overlap within the out-coupling diffractive optic, wherein the first and second set of diffractive features introduce an optical power to change a focusing distance of the first wavelength range and the second wavelength range of image-bearing light beams.

In an exemplary embodiment, the first set of diffractive features and the second set of diffractive features each introduce a different optical power. In an exemplary embodiment the image light guide further comprises a first turning optic operable to turn image-bearing light received from the first input region of the in-coupling diffractive optic toward the out-coupling diffractive optic. In an exemplary embodiment, the image light guide comprises a second turning optic operable to turn image-bearing light received from the second input region of the in-coupling diffractive optic toward the out-coupling diffractive optic. In an exemplary embodiment, each diffractive feature of the first set of diffractive features is curved. In an exemplary embodiment, each diffractive feature of the second set of diffractive features is curved. In an exemplary embodiment, the out-coupling diffractive optic includes a two-dimensional array of zones, wherein each zone comprises one or more of the first set of diffractive features and the second set of diffractive features, wherein each diffractive feature of the first set of diffractive features and the second set of diffractive features is linear, wherein each zone has a common pitch between each diffractive feature of the first and second sets of diffractive features, wherein the common pitch varies between successive zones in at least a first dimension of the two-dimensional array.

In an exemplary embodiment, the first set of diffractive features vary in pitch. In an exemplary embodiment, the second set of diffractive features vary in pitch. In an exemplary embodiment, the first set of diffractive features in the successive zones along the first dimension are oriented in a constant direction, and successive zones along a second dimension of the array are oriented in different directions in a manner that progressively varies in a stepwise manner between the successive zones along the second dimension. In an exemplary embodiment, the second set of diffractive features in the successive zones along the first dimension are oriented in different directions in a manner that progressively varies in a stepwise manner between the successive zones along the first dimension, and successive zones along the second dimension are oriented in a constant direction. In an exemplary embodiment, the first wavelength range of image-bearing light comprises red light. In an exemplary embodiment, the second wavelength range of image-bearing light comprises blue light. In an exemplary embodiment, the first set of diffractive features comprises a first pitch progression and the second set of diffractive features comprises a second pitch progression, the second pitch progression being equal to the first pitch progression. In an exemplary embodiment, the first input region comprises a first pitch and the second input region comprises a second pitch. In an exemplary embodiment, at least one of the first set of diffractive features and the second set of diffractive features comprise blazed, slanted, or hybrid grating features.

The image light guide can include a frame, an image source connected to the frame, wherein the image source is operable to emit image-bearing light of a first wavelength range and a second wavelength range, and a waveguide connected to the frame, including an in-coupling diffractive optic comprising a first input region and a second input region, the first input region operable to couple image-bearing light of the first wavelength range into the waveguide and the second input region operable to couple image-bearing light of the second wavelength range into the waveguide, and an out-coupling diffractive optic comprising a first set of diffractive features and a second set of diffractive features, wherein the first set of diffractive features and the second set of diffractive features at least partially overlap within the out-coupling diffractive optic and wherein the first set of diffractive features and the second set of diffractive features are operable to form a virtual image that is viewable from a viewer eyebox, wherein at least the first set of diffractive features introduce an optical power that changes a focusing distance of the virtual image.

In an exemplary embodiment, the first set of diffractive features and the second set of diffractive features introduce an optical power and change the focusing distance of the virtual image. In an exemplary embodiment, the image light guide comprises a first turning optic operable to turn image-bearing light received from the first input region of the in-coupling diffractive optic. In an exemplary embodiment, the image light guide comprises a second turning optic operable to turn image-bearing light received from the second input region of the in-coupling diffractive optic. In an exemplary embodiment, at least one of the first set of diffractive features and the second set of diffractive features vary in pitch.

The present disclosure utilizes a split in-coupling diffractive optic that is optimized to in-couple light from two ranges of wavelengths (e.g., blue and red). The out-coupling optic includes two sets of diffractive features (e.g., one set of gratings optimized to out-couple a blue wavelength range of light and the other set of gratings optimized to out-couple a red wavelength range of light), where the two sets of output gratings overlap and are curved or segmented to introduce optical power, thereby forming a complex out-coupling optic within a single waveguide. In an exemplary embodiment, each set of out-coupling diffractive features introduces a different optical or dioptric power (e.g., the image light guide is operable to form a first virtual image at a first distance and a second virtual image at a second distance).

In an exemplary embodiment, the present disclosure provides a multi-input, multiplexed image light guide with a complex, powered, outcoupling grating, all within a single waveguide. The waveguide includes a single input split into two sections, a first section optimized for in-coupling light from within a first wavelength range (e.g., blue) into the waveguide and a second section for coupling light from within a second wavelength range (e.g., red) into the waveguide. The waveguide can also include two turning diffractive optics, one being optimized for each wavelength range. The out-coupling optic includes a complex grating pattern of two overlapping sets of gratings. The first output grating set is optimized for the first wavelength range and is chirped (i.e., has a progressively increasing pitch in one direction). The second output grating set is optimized for the second wavelength range and is also chirped in a second direction with the same progression as the first output grating set. Each grating row/column of grating features within each output grating set can be curved or segmented to introduce optical power for each respective wavelength range.

It should be appreciated that it is not necessary to optimize for green light as the wavelength range for green light is between the wavelength ranges of red and blue. Gratings that are optimized for red or blue light will still diffract light within the green range, albeit less efficiently. Thus, in an exemplary embodiment, the image light guide optimizes for red light and blue light, and image-bearing light in the green range will be in-coupled and out-coupled evenly by the red and blue gratings. It should further be appreciated that the image light guide of the present disclosure is operable to optimize two spectral ranges or wavelengths (i.e., for any pitch/wavelength range), and is not limited to optimization of just red and blue light.

In an exemplary embodiment, the path for each wavelength range includes in-coupling, even coupling within the in-coupling diffractive optic to the turning or intermediate optic, odd coupling from the turning optic to the outcoupling diffractive optic. It should be appreciated that, although not required, the image light guide described herein could be utilized to introduce 2D eyebox expansion.

These and other aspects, objects, features, and advantages of the present disclosure will be more clearly understood and appreciated from the following detailed description of the embodiments and appended claims, and by reference to the accompanying drawing figures.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top view of an image light guide with an exaggerated thickness for showing the propagation of light from an image source along the image light guide to an eyebox within which the virtual image can be viewed.

FIG. 2 is a perspective view of an image light guide including an in-coupling diffractive optic, a turning diffractive optic, and an out-coupling diffractive optic for managing the propagation of image-bearing light beams.

FIG. 3 is a schematic plan view of an image light guide having a split in-coupling diffractive optic and a plurality of patterns of diffractive features according to an exemplary embodiment of the presently disclosed subject matter.

FIG. 4 is a perspective view of an image light guide system including the image light guide of FIG. 3.

FIG. 5 is a cross-sectional side view of a portion of a diffractive optic featuring a progressive variation in pitch along a first dimension of the diffractive optic for generating a virtual focus for one dimension of an image.

FIG. 6 is a perspective view of a display system for augmented reality viewing using at least one image light guide according to an exemplary embodiment of the presently disclosed subject matter.

FIG. 7 is a front view of a portion of an out-coupling diffractive optic featuring an array of zones, each zone having a common pitch between each diffractive feature of the first and second sets of output diffractive features, the common pitch varying between zones in at least a first dimension according to an exemplary embodiment of the presently disclosed subject matter.

FIG. 8 is a front view of a portion of an out-coupling diffractive optic featuring an array of unit cells according to an exemplary embodiment of the presently disclosed subject matter.

FIG. 9 is a cross-sectional side view of a portion of a diffractive optic including diffractive features with square gratings.

FIG. 10 is a cross-sectional side view of a portion of a diffractive optic including diffractive features with blazed gratings.

FIG. 11 is a cross-sectional side view of a portion of a diffractive optic including diffractive features with slanted gratings.

FIG. 12 is a cross-sectional side view of a portion of a diffractive optic including diffractive features with hybrid slanted gratings.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first,” “second,” and so on, do not necessarily denote any ordinal, sequential, or priority relation, but are simply used to more clearly distinguish one element or set of elements from another, unless specified otherwise.

Where used herein, the terms “viewer,” “operator,” “observer,” and “user” are considered equivalents and refer to the person or machine who wears and/or views images using a device having an image light guide. Where used herein, the term “set” refers to a non-empty set, as the concept of a collection of elements or members of a set is widely understood in elementary mathematics. The term “subset,” unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the term “beam expansion” is intended to mean replication of a beam via multiple encounters with an optical element to provide exit pupil expansion in one or more dimensions. Similarly, where used herein, the terms “expanded image-bearing light beams” and “expanded set of angularly related beams” refer to a light beam replicated via multiple encounters with an optical element to provide exit pupil expansion in one or more dimensions.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

Where used herein, the term “exemplary” is intended to mean “an example of,” “serving as an example,” or “illustrative,” and does not denote any preference or requirement with respect to a disclosed aspect or embodiment.

An optical system, such as a HMD, can produce a virtual image display. In contrast to methods for forming a real image, a virtual image is not formed on a display surface. That is, if a display surface were positioned at the perceived location of a virtual image, no image would be formed on that surface. Virtual image display has a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or integrated within the waveguide. Such diffractive optics can be formed as diffraction gratings, holographic optical elements (HOEs), or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along one dimension of the virtual image. In addition, a turning grating can be positioned on/in the waveguide to provide pupil expansion in an orthogonal dimension of the virtual image. The image-bearing light output from the waveguide provides an expanded eyebox for the viewer.

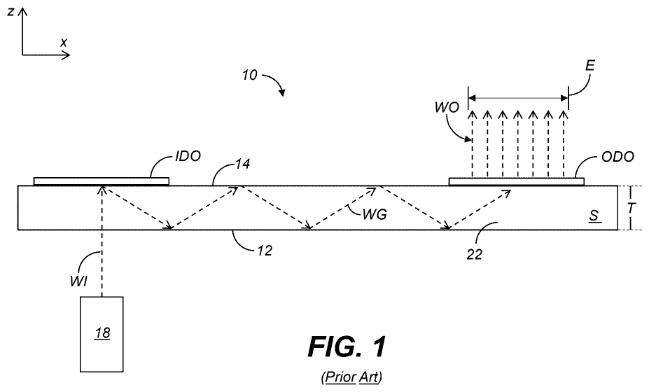

As illustrated in FIG. 1, image light guide 10 may comprise planar waveguide 22 having plane-parallel surfaces 12, 14. Waveguide 22 comprises transparent substrate S, which, for example, can be made of optical glass or plastic, having plane parallel first and second surfaces 12, 14. In this example, in-coupling diffractive optic IDO and out-coupling diffractive optic ODO are arranged on second surface 14, and in-coupling diffractive optic IDO is a reflective-type diffraction grating through which image-bearing light WI is coupled into planar waveguide 22. However, in-coupling diffractive optic IDO could alternately be a volume hologram or other holographic diffraction element, or other type of optical component that provides diffraction for the incoming, image-bearing light WI. In-coupling diffractive optic IDO can be located on first surface 12 or second surface 14 of planar waveguide 22 and can be of a transmissive or reflective type depending upon the direction from which image-bearing light WI approaches planar waveguide 22.

When used as a part of a virtual display system, in-coupling diffractive optic IDO couples image-bearing light WI from real image source 18 into substrate S of planar waveguide 22. Any real image or image dimension is first converted into an array of overlapping angularly related beams encoding the different positions within an image for presentation to in-coupling diffractive optic IDO. Image-bearing light WI is diffracted (generally through a first diffraction order) and thereby redirected by in-coupling diffractive optic IDO into planar waveguide 22 as image-bearing light WG for further propagation along planar waveguide 22 by Total Internal Reflection (“TIR”). Although diffracted into a generally more condensed range of angularly related beams in keeping with the boundaries set by TIR, image-bearing light WG preserves the image information in an encoded form. Out-coupling diffractive optic ODO receives the encoded image-bearing light WG and diffracts (also generally through a first diffraction order) image-bearing light WG out of planar waveguide 22 as image-bearing light WO toward the intended location of a viewer's eye. Generally, out-coupling diffractive optic ODO is designed symmetrically with respect to in-coupling diffractive optic IDO to restore the original angular relationships of image-bearing light WI among outputted angularly related beams of image-bearing light WO. However, to increase one dimension of overlap among the angularly related beams in a so-called eyebox E within which the virtual image can be seen, out-coupling diffractive optic ODO is arranged to encounter image-bearing light WG multiple times and to diffract only a portion of image-bearing light WG on each encounter. The multiple encounters along the length of out-coupling diffractive optic ODO have the effect of enlarging one dimension of each of the angularly related beams of image-bearing light WO thereby expanding one dimension of eyebox E within which the beams overlap. Expanded eyebox E decreases sensitivity to the position of a viewer's eye for viewing the virtual image.

Out-coupling diffractive optics with refractive index variations along a single dimension can expand one dimension of the eyebox by replicating the individual angularly related beams in their direction of propagation along the waveguide between encounters with the out-coupling diffractive optic. In addition, out-coupling diffractive optics with refractive index variations along a second dimension can expand a second dimension of the eyebox and provide two-dimensional expansion of the eyebox. The refractive index variations along a first dimension of the out-coupling diffractive optic can be arranged to diffract a portion of each beam's energy out of the waveguide upon each encounter therewith through a desired first order of diffraction, while another portion of the beam's energy is preserved for further propagation in its original direction through a zero order of diffraction. The refractive index variations along a second dimension of the out-coupling diffractive optic can be arranged to diffract a portion of each beam's energy upon each encounter therewith through a desired first order of diffraction in a direction angled relative to the beam's original direction of propagation, while another portion of the beam's energy is preserved for further propagation in its original direction through a zero order of diffraction.

Out-coupling diffractive optic ODO is shown as a transmissive-type diffraction grating arranged on second surface 14 of planar waveguide 22. However, like in-coupling diffractive optic IDO, out-coupling diffractive optic ODO can be located on first surface 12 or second surface 14 of planar waveguide 22 and be of a transmissive or reflective type in a combination that depends upon the direction through which image-bearing light WG is intended to exit planar waveguide 22.

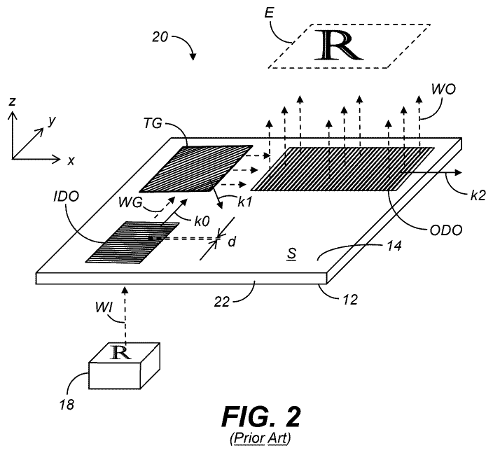

As illustrated in FIG. 2, image light guide 20 may be arranged for expanding eyebox E in two dimensions, i.e., along both x- and y-axes of the intended image. To achieve a second dimension of beam expansion, in-coupling diffractive optic IDO, having grating vector k0, is oriented to diffract a portion of image-bearing light WI toward intermediate optic TO, having grating vector k1, which is oriented to diffract a portion of image-bearing light WG in a reflective mode toward out-coupling diffractive optic ODO. Intermediate optic TO may be referred to herein as a turning grating or turning optic. In an embodiment, intermediate optic TO is a surface relief grating. In another embodiment, intermediate optic TO is a holographic optical element. Only a portion of image-bearing light WG is diffracted by each of multiple encounters with intermediate optic TO thereby laterally replicating each of the angularly related beams of image-bearing light WG approaching out-coupling diffractive optic ODO. Intermediate optic TO redirects image-bearing light WG toward out-coupling diffractive optic ODO for longitudinally replicating the angularly related beams of image-bearing light WG in a second dimension before exiting planar waveguide 22 as he image-bearing light WO. Grating vectors, such as the depicted grating vectors k0, k1, k2, extend in a direction that is normal to the diffractive features (e.g., grooves, lines, or rulings) of the diffractive optics and have a magnitude inverse to the period or pitch d (i.e., the on-center distance between grooves) of diffractive optics IDO, TO, ODO. In-coupling diffractive optic IDO, intermediate optic TO, and out-coupling diffractive optic ODO may each have a different period or pitch d.

With continued reference to FIG. 2, in-coupling diffractive optic IDO receives incoming image-bearing light WI containing a set of angularly related beams corresponding to individual pixels or equivalent locations within an image generated by image source 18. Image source 18, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. In some examples, image source 18 comprises one or more light-emitting diodes (LEDs), organic LEDs (OLEDs), or ultra LEDs (uLEDs). In other examples, image source 18 is a color field sequential projector system operable to pulse image-bearing light of multiple wavebands, for example light from within red, green, and blue wavelength ranges, onto a digital light modulator/micro-mirror array (a “DLP”) or a liquid crystal on silicon (“LCOS”) display. In further examples, image source 18 includes one or more pico-projectors, where each pico-projector is configured to produce a single primary color band (e.g., red, green, or blue). In another example, image source 18 includes a single pico-projector arranged to produce all three primary color bands (e.g., red, green, and blue). In one example, the three primary color bands are a green band having a wavelength in the range between 495 nm and 570 nm, a red band having a wavelength in the range between 620 nm and 750 nm, and a blue band having a wavelength in the range between 450 nm and 495 nm.

Image light guide 20 outputs an expanded set of angularly related beams in two dimensions of the image by providing multiple encounters of image-bearing light WG with both intermediate optic TO and out-coupling diffractive optic ODO in different orientations. In the original orientation of planar waveguide 22, intermediate grating TO provides beam expansion in the y-axis direction, and out-coupling diffractive optic ODO provides a similar beam expansion in the x-axis direction. The reflectivity characteristics and respective periods d of diffractive optics IDO, ODO, TO, together with the orientations of their respective grating vectors, provide for beam expansion in two dimensions while preserving the intended relationships among the angularly related beams of image-bearing light WI that are output from image light guide 20 as image-bearing light WO.

While image-bearing light WI input into image light guide 20 is encoded into a different set of angularly related beams by in-coupling diffractive optic IDO, the information required to reconstruct the image is preserved by accounting for the systematic effects of in-coupling diffractive optic IDO. Intermediate optic TO, located in an intermediate position between in-coupling and out-coupling diffractive optics IDO, ODO, is typically arranged so that it does not induce any significant change on the encoding of image-bearing light WG. Out-coupling diffractive optic ODO is typically arranged in a symmetric fashion with respect to in-coupling diffractive optic IDO, e.g., including diffractive features sharing the same period. Similarly, the period of intermediate optic TO also typically matches the common period of in-coupling and out-coupling diffractive optics IDO, ODO. As illustrated in FIG. 2, grating vector k1 of intermediate optic TO may be oriented at forty-five degrees (45°) with respect to the other grating vectors k0, k2 (all as undirected line segments). However, in an embodiment, grating vector k1 of the intermediate optic TO is oriented at sixty degrees (60°) to grating vectors k0, k2 of in-coupling and out-coupling diffractive optics IDO, ODO in such a way that image-bearing light WG is turned one hundred and twenty degrees (120°). By orienting grating vector k1 of intermediate optic TO at sixty degrees (60°) with respect to grating vectors k0, k2 of in-coupling and out-coupling diffractive optics IDO, ODO, grating vectors k0, k2 are also oriented at sixty degrees (60°) with respect to each other (again considered as undirected line segments). The three grating vectors k0, k1, k2 (as directed line segments) form an equilateral triangle, and sum to a zero-vector magnitude, which avoids asymmetric effects that could introduce unwanted aberrations including chromatic dispersion.

Image-bearing light WI that is diffracted into planar waveguide 22 is effectively encoded by in-coupling diffractive optic IDO, whether in-coupling diffractive optic IDO uses gratings, holograms, prisms, mirrors, or some other mechanism. Any reflection, refraction, and/or diffraction of light that takes place at in-coupling diffractive optic IDO must be correspondingly decoded by out-coupling diffractive optic ODO to re-form the virtual image that is presented to the viewer. Intermediate optic TO, placed at an intermediate position between in-coupling and out-coupling diffractive optics IDO, ODO, is typically designed and oriented so that it does not induce any change on the encoded light. Out-coupling diffractive optic ODO decodes image-bearing light WG into its original or desired form of angularly related beams that have been expanded to fill eyebox E.

Whether any symmetries are maintained or not among intermediate optic TO and in-coupling and out-coupling diffractive optics IDO, ODO, or whether any change to the encoding of the angularly related beams of image-bearing light WI takes place along planar waveguide 22, intermediate optic TO and in-coupling and out-coupling diffractive optics IDO, ODO are related so that image-bearing light WO that is output from planar waveguide 22 preserves or otherwise maintains the original or desired form of image-bearing light WI for producing the intended virtual image.

The letter “R” represents the orientation of the virtual image that is visible to the viewer whose eye is in eyebox E. As shown, the orientation of the letter “R” in the represented virtual image matches the orientation of the letter “R” as encoded by image-bearing light WI. A change in the rotation about the z-axis or angular orientation of incoming image-bearing light WI with respect to the x-y plane causes a corresponding symmetric change in rotation or angular orientation of outgoing light from out-coupling diffractive optic ODO. From the aspect of image orientation, intermediate optic TO simply acts as a type of optical relay, providing expansion of the angularly encoded beams of image-bearing light WG along one axis (e.g., along the y-axis) of the image. Out-coupling diffractive optic ODO further expands the angularly encoded beams of image-bearing light WG along another axis (e.g., along the x-axis) of the image while maintaining the original orientation of the virtual image encoded by image-bearing light WI. As illustrated in FIG. 2, intermediate optic TO may be a slanted or square grating arranged on the front or back (i.e., first or second) surfaces of planar waveguide 22. Alternately, intermediate optic TO may be a blazed grating.

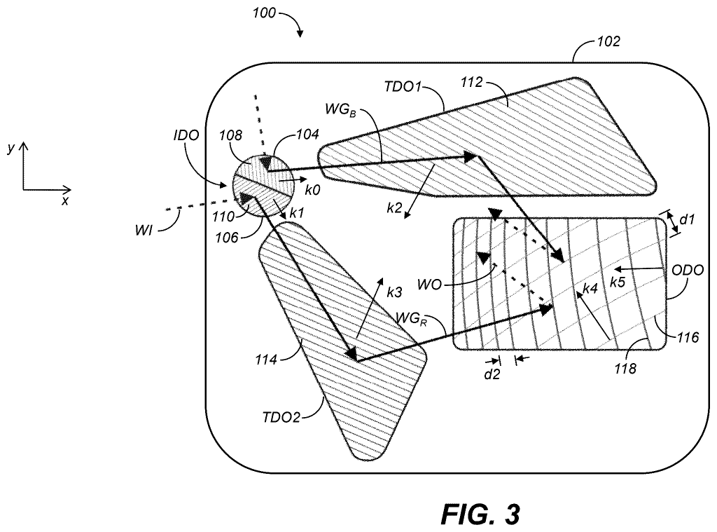

As illustrated in FIG. 3, in an example embodiment, image light guide 100 includes in-coupling diffractive optic IDO and out-coupling diffractive optic ODO formed on, in, or along first surface 102 of image light guide 100. In an example embodiment, image light guide 100 further includes intermediate diffractive optic TDO1 and/or intermediate diffractive optic TDO2. Alternately, one or more of in-coupling, intermediate, and out-coupling diffractive optics IDO, TDO1, TDO2, ODO can be formed on, in, or along the second surface of image light guide 100 located opposite first surface 102.

In an example embodiment, image light guide 100 comprises a split in-coupling diffractive optic IDO including first input region or portion 104 and second input region or portion 106. First portion 104 is optimized to in-couple light of a first wavelength range (e.g., blue light in the 440-470 nm range or between 450-495 nm) and second portion 106 is optimized to in-couple light of a second wavelength range (e.g., red light in the 630-660 nm range or between 620-750 nm), different than the first wavelength range. First portion 104 comprises a pattern of diffractive features 108 having first grating vector k0 and second portion 106 comprises a pattern of diffractive features 110 having second grating vector k1. In an example embodiment, the diffractive features 108, 110 comprise a plurality of posts. In another example embodiment, the diffractive features 108, 110 comprise a plurality of linear diffractive features.

It should be appreciated that while FIG. 3 shows the geometric size and shape of first portion 104 and second portion 106 being equal, in an exemplary embodiment, first portion 104 may comprise a geometric size and/or shape that differs from that of second portion 106.

Out-coupling diffractive optic ODO comprises a first set of diffractive features 116 and a second set of diffractive features 118. First set of grating features 116 is optimized to out-couple a first wavelength range of light (e.g., blue light) and second set of grating features 118 is optimized to out-couple a second wavelength range of light (e.g., red light). In an exemplary embodiment, as illustrated in FIG. 3, the first and second sets of grating features 116 and 118 at least partially overlap and are curved (i.e., curvilinear) or approximate a curve with linear segments to introduce optical power. In an exemplary embodiment, first set of grating features 116 is chirped in a first direction, meaning grating features 116 progressively increase in pitch in one direction. For example, as shown in FIG. 3, first set of grating features 116 have a pitch d1 progressively increasing in pitch in a first direction (i.e., a direction opposite to the direction of grating vector k4). In an exemplary embodiment, second set of grating features 118 is chirped in a second direction different from the first direction. For example, as shown in FIG. 3, second set of grating features 118 comprises pitch d2 progressively increasing in pitch in a second direction (i.e., a direction opposite to the direction of grating vector k5). In an exemplary embodiment, the pitch progression of second set of grating features 118 is equal to the pitch progression of first set of grating features 116. In other exemplary embodiments, the pitch progression of the second set of grating features 118 is not equal to the pitch progression of the first set of grating features 116.

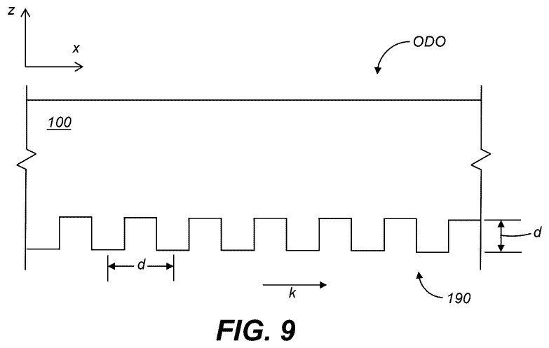

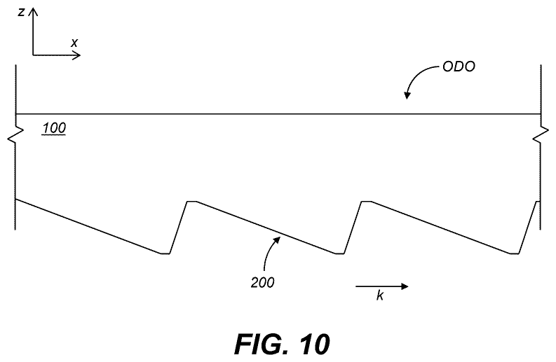

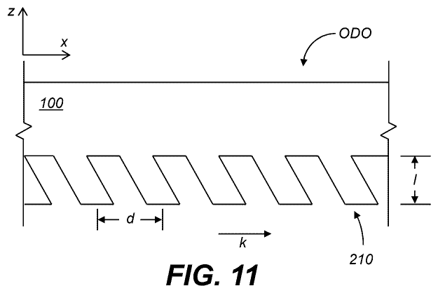

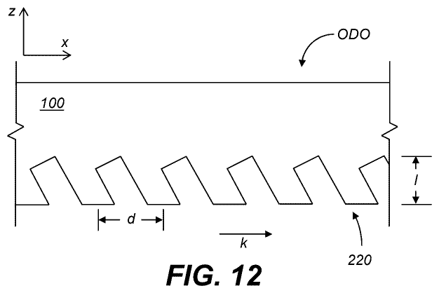

In an exemplary embodiment, diffractive features 116 and/or diffractive features 118 comprise square gratings. FIG. 9 shows an exemplary embodiment of out-coupling diffractive optic ODO comprising diffractive features having square gratings 190. Square gratings 190 comprise pitch d and depth 1. In an exemplary embodiment, depth/is equal to pitch d/2. In an exemplary embodiment, diffractive features 116 and/or diffractive features 118 directional gratings such as blazed gratings, slanted gratings, or a hybrid thereof. Such grating geometries have a direction sensitivity, i.e., a higher coupling efficiency in a particular propagation direction. FIG. 10 shows an exemplary embodiment of out-coupling diffractive optic ODO comprising diffractive features having blazed gratings 200. In an exemplary embodiment, each of blazed gratings 200 comprise at least one surface arranged non-parallel to a surface of image light guide 100. FIG. 11 shows an exemplary embodiment of out-coupling diffractive optic ODO comprising diffractive features having slanted gratings 210. Slanted gratings 210 comprise pitch d and depth 1. In an exemplary embodiment, each of slanted gratings 210 comprise two surfaces that are parallel to each other but non-parallel to a surface of image light guide 100, and one surface that connects the two surfaces and is parallel to a surface of image light guide 100. FIG. 12 shows an exemplary embodiment of out-coupling diffractive optic ODO comprising diffractive features having hybrid slanted gratings 220. Hybrid slanted gratings 220 comprise pitch d and depth 1. In an exemplary embodiment, each of slanted gratings 220 comprises two surfaces that are parallel to each other but non-parallel to a surface of image light guide 100, and one surface that is perpendicular to and connects the two surfaces.

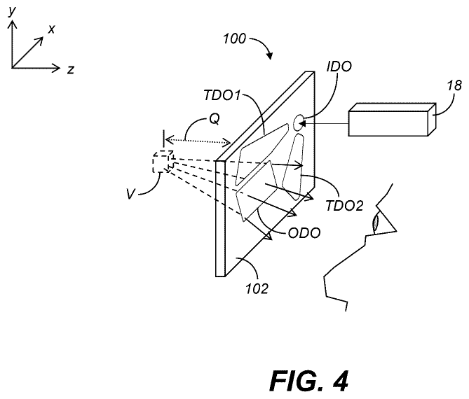

Referring now to FIGS. 3 and 4, the principal rays that are outcoupled from out-coupling diffractive optic ODO form virtual image V within eyebox E of the user. The diverging principal rays converge at a virtual location in front of image light guide 100 such that virtual image V appears at a location at a finite near-focus distance Q in front of image light guide 100. Thus, each of the angularly related beams of the image-bearing light is no longer collimated, i.e., diverging from a point at infinity, but is instead a beam that appears to diverge from a point located much closer to image light guide 100. In at least FIG. 4, the diverging principal rays formed by the light rays exiting from image light guide 100 are schematically indicated in solid lines. The dashed lines are extensions of the principal rays that schematically indicate, to the eye of the viewer, the apparent source of the object point in virtual image V.

Virtual image content that appears to be at a shorter focus distance than the conventional infinity focus provides additional control over the way in which virtual images can be presented to viewers such as by presenting images of objects at a perceived distance in front of other objects within the viewer's field of view. Near or finite focal distance Q can be at any distance within about 1 meter to 2 meters, such as at about 0.6 m from image light guide 100, for example. In order to form a virtual image that appears to have a finite focal distance, each of the angularly related beams of the image bearing light that is emitted from the out-coupling diffractive optic ODO has its principal rays diverging from the apparent location within the virtual image that is positioned at the near focus distance Q. The near focusing of each of the otherwise collimated beams among the set of angularly related beams does not change the relative positions at which the beams appear to be focused within the virtual image. Instead, the entire virtual image appears closer to the viewer.

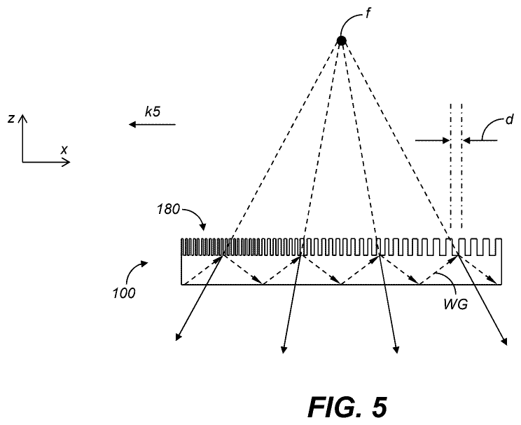

One mechanism for converting a dimension of a collimated beam propagating along the image light guide 100 into a diverging beam representing a near focus position in a virtual image is presented in FIG. 5 as a stepped-chirp diffraction grating 180 (e.g., comprising diffractive features 118 of out-coupling diffractive optic ODO) operating in a reflective mode. Grating vector k5 extends parallel to the x-axis in a direction opposite to the direction along which the collimated beam is propagated. Grating period d of diffraction grating 180 increases in a stepwise manner along the same direction of propagation. Because the angle through which a given beam is diffracted is inversely proportional to the period of a diffraction grating, the angle through which the collimated beam is diffracted decreases with successive encounters of the collimated beam along the stepped-chirp diffraction grating 180. At the start of diffraction grating 180, first encountered by the collimated beam, period d is relatively shortened so that the diffraction angle is increased and at the end of grating 180, period d is relatively lengthened so that the diffraction angle is decreased.

Considered in the x-z plane, stepwise adjustments to period d along the x-axis length of diffraction grating 180 provide for diffracting the representative collimated beam through progressively varying diffraction angles so that the light appears to emanate from near-focus point f. The other angularly related beams of image bearing light WG are also diffracted through a progression of different diffraction angles with each successive encounter with diffraction grating 180 so that the light from each of these beams appears to emanate from a different near-focus point elsewhere in a common focal plane at distance Q in accordance with their differing angular content.

As described above, it should be appreciated that it is not necessary to optimize for out-coupling of green light as the wavelength range for green light falls between the wavelength ranges of red and blue light. Thus, in an exemplary embodiment, image light guide 100 optimizes for red light and blue light, and green light will be in-coupled by diffractive features 108, 110 of in-coupling diffractive optic IDO, albeit potentially less efficiently. It should be further appreciated that image light guide 100 is operable to optimize two spectral ranges or wavelengths (i.e., for any pitch/wavelength range), and is not limited to optimization of just red and blue light.

In an exemplary embodiment, image light guide 100 further comprises turning gratings or intermediate diffractive optics TDO1, TDO2. In an exemplary embodiment, the path for each wavelength range of image-bearing light includes in-coupling optic IDO, intermediate diffractive optic TDO1 and/or intermediate diffractive optic TDO2, and out-coupling diffractive optic ODO. In image light guide 100, image-bearing light WG is directed from in-coupling diffractive optic IDO to intermediate diffractive optics TDO1, TDO2 after even numbers of incidents upon diffractive features, and image-bearing light WG is directed from intermediate diffractive optics TDO1, TDO2 to out-coupling diffractive optic ODO after odd numbers of incidents upon diffractive features. It should be appreciated that image light guide 100 described herein could be utilized to introduce 2D eyebox expansion.

With reference to FIG. 3, in an example embodiment, in-coupling diffractive optic IDO is configured to direct a portion of a first wavelength range of image-bearing light WG_{B} toward intermediate diffractive optic TDO1, having third grating vector k2, which is oriented to diffract a portion of image-bearing light WG_{B} in a reflective mode toward out-coupling diffractive optic ODO. In an exemplary embodiment, only a portion of image-bearing light WG_{B} is diffracted by each of multiple encounters with intermediate diffractive optic TDO1, thereby laterally replicating each of the angularly related beams of image-bearing light WG_{B} directed to out-coupling diffractive optic ODO. In an embodiment, intermediate diffractive optic TDO1 includes a pattern of linear diffractive features 112.

In an example embodiment, in-coupling diffractive optic IDO is configured to direct a portion of a second wavelength range of image-bearing light WG_{R} toward intermediate diffractive optic TDO2, having fourth grating vector k3, which is oriented to diffract a portion of image-bearing light WG_{R} in a reflective mode toward out-coupling diffractive optic ODO. In an exemplary embodiment, only a portion of the image-bearing light WG_{R} is diffracted by each of multiple encounters with intermediate diffractive optic TDO2, thereby laterally replicating each of the angularly related beams of image-bearing light WG_{R} directed to out-coupling diffractive optic ODO. In an embodiment, intermediate diffractive optic TDO2 includes a pattern of linear diffractive features 114.

In an example embodiment, out-coupling diffractive optic ODO includes a pattern of diffractive features 116 having fifth grating vector k4 and a pattern of diffractive features 118 having sixth grating vector k5. For example, diffractive features 116, 118 may comprise a plurality of curvilinear elements. In an exemplary embodiment, in-coupling diffractive optic IDO is configured to direct a portion of a first wavelength range of image-bearing light WG_{B} toward diffractive features 116 of out-coupling diffractive optic ODO. Diffractive features 116, having fifth grating vector k4, are optimized to diffract a portion of image bearing light WG_{B} in a reflective (or transmissive) mode to provide pupil expansion, and to out-couple a portion of image-bearing light WG_{B} toward an eyebox. In an exemplary embodiment, in-coupling diffractive optic IDO is configured to direct a portion of a second wavelength range of image-bearing light WG_{R} toward diffractive features 118 of out-coupling diffractive optic ODO. Diffractive features 118, having sixth grating vectors k5, are optimized to diffract a portion of image-bearing light WG_{R} in a reflective (or transmissive) mode to provide pupil expansion, and to out-couple a portion of image-bearing light WG_{R} toward an eyebox.

In a first optical path, image-bearing light having a first wavelength range WG_{B}(e.g., blue light) is: diffracted by first portion 104 of in-coupling diffractive optic IDO (via interaction with linear diffractive features 108 having first grating vector k0); diffracted by intermediate diffractive optic TDO1 (via interaction with linear diffractive features 112 having third grating vector k2); and diffracted by out-coupling diffractive optic ODO (via interaction with diffractive features 116 having fifth grating vector k4). First, third, and fifth grating vectors k0, k2, k4 create a vector summation of substantially zero magnitude. In a second optical path, image-bearing light having a second wavelength range WG_{R} (e.g., red light) is: diffracted by second portion 106 of in-coupling diffractive optic IDO (via interaction with linear diffractive features 110 having second grating vector k1); diffracted by intermediate diffractive optic TDO2 (via interaction with linear diffractive features 114 having fourth grating vector k3); and diffracted by out-coupling diffractive optic ODO (via interaction with diffractive features 118 having sixth grating vector k5). Second, fourth, and sixth grating vectors k1, k3, k5 create a vector summation of substantially zero magnitude.

The perspective view of FIG. 4 shows an embodiment of image source 18 emitting image-bearing light incident on in-coupling diffractive optic IDO of image light guide 100. Out-coupling diffractive optic ODO, configured using the overlapping chirped arrangement of diffractive features described herein, provides near-focus imaging to form a polychromatic virtual image V at distance Q. Although FIGS. 3-4 show in-coupling diffractive optic IDO split into two portions 104, 106, in an exemplary embodiment image light guide 100 could also be configured with two separate in-coupling diffractive optics, one optimized for a first wavelength range and the other optimized for a second wavelength range, as described herein. Likewise, while FIGS. 3-4 illustrate a single out-coupling diffractive optic ODO including overlaying sets of diffractive features 116, 118, in an exemplary embodiment image light guide 100 could be configured with two separate out-coupling diffractive optics, one optimized for a first wavelength range and the other optimized for a second wavelength range, as described herein.

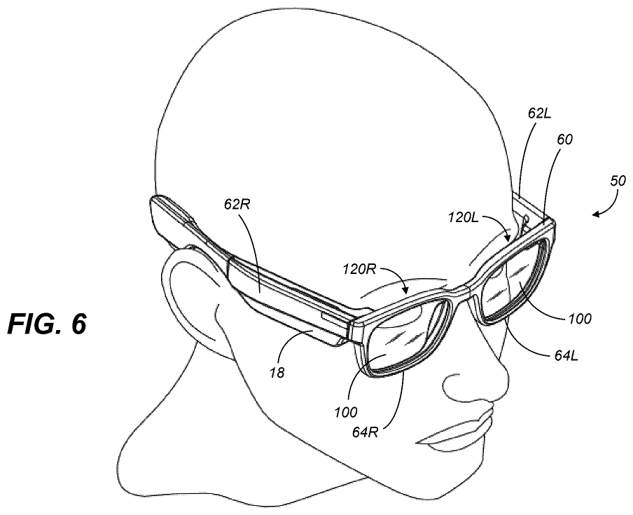

The perspective view shown in FIG. 6 illustrates one example of image light guide system 50 in a display system for augmented reality viewing of virtual images. Image light guide system 50 uses one or more image light guides 100. Image light guide system 50 is shown as a HMD having eyeglasses frame (e.g., ophthalmic frame) 60 including one or more temples, for example temples 62R, 62L, and image light guides 100 held in place by rims 64R, 64L. Temples 62R, 62L are hingedly connected to rims 64R, 64L, respectively, and rims 64R, 64L are connected via a bridge. As shown, right-eye optical system 120R including image light guide 100 is arranged proximate the user's right eye. Image light guide system 50 includes image source 18, such as a pico-projector or similar device, energizable to generate one or more polychromatic virtual images. In one example embodiment, image source 18 is secured to or secured within a temple, e.g., at least one of temples 62R or 62L, and may be completely or partially encompassed by the structure of the temple. In an exemplary embodiment, image source 18 is connected to one of temples 62R and 62L, and is arranged to emit image-bearing light optically toward the respective image light guide 100. In another exemplary embodiment, image source 18 is arranged in one of temples 62R and 62L, and is arranged to emit image-bearing light optically toward the respective image light guide 100. Image source 18 may comprise electronics, one or more batteries, a controller, or any component suitable for generating a full range of angularly encoded beams for producing an image. In one example, image light guide system 50 includes left-eye optical system 120L having one or more image light guides 100 and a second image source. In examples using right-eye optical system 120R and left eye-optical system 120L, the virtual images that are generated can be a stereoscopic pair of images for three-dimensional (3D) viewing. During operation by a user, the virtual image or images formed by image light guide system 50 can appear to be superimposed or overlaid onto the real-world scene content seen by the viewer through right eye optical system 120R and/or left eye optical system 120L. Additional components familiar to those skilled in the augmented reality visualization arts, such as one or more cameras mounted on the frame of the HMID for viewing scene content or viewer gaze tracking, can also be provided.

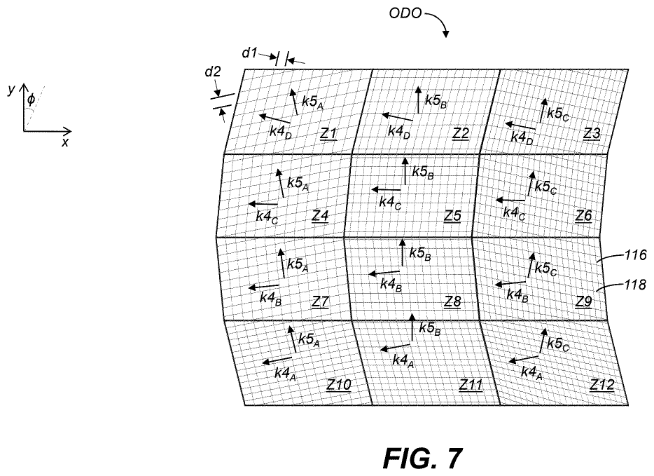

FIG. 7 shows, in simplified schematic form, a portion of an exemplary embodiment of out-coupling diffractive optic ODO that is divided into a two-dimensional array of zones, for example zones Z1-Z12. Each of zones Z1-Z12 includes a set of linear diffractive features 116, 118, which extend parallel to each other and have equal pitch within each respective zone Z1-Z12. For example, zone Z1 includes diffractive features 116 including pitch d1 and diffractive features 118 including pitch d2. In an exemplary embodiment, pitch d1 is equal to pitch d2. In other example embodiments, pitch d1 is not equal to pitch d2. In an exemplary embodiment, each zone has the form of a diffractive optical element with crossed linear diffractive features.

Diffractive features 116 exhibit a stepwise variation in pitch d1 along the x-axis dimension of the array, referred to as rows. Thus, in an example, pitch d1 in zone Z1 is greater than pitch d1 in zone Z2, which is greater than pitch d1 in zone Z3. In addition to its ordinary meaning to those in the art, the term “stepwise variation” is intended to describe that the common pitch (e.g., pitch d1) between diffractive features of the same zone is constant, but the common pitch d1 in each successive zone along the x-axis dimension of the array changes, e.g., increases or decreases. Additionally, diffractive features 116 comprise the same (e.g., constant) curvature/grating orientation along the x-axis, namely, diffractive features 116 have the same grating vector k4_{D} across zones Z1-Z3 (i.e., the angle of diffractive features 116 across zones Z1-Z3 are the same, and thus diffractive features 116 across zones Z1-Z3 are parallel to each other). This same behavior occurs with respect to diffractive features 116 across the x-axis throughout the array. Diffractive features 116 exhibit a stepwise variation in pitch d1, e.g., decreasing in each successive zone across zones Z4-Z6, and a constant grating vector k4_{C}. Diffractive features 116 exhibit a stepwise variation in pitch d1, decreasing in each successive zone across zones Z7-Z9, and a constant grating vector k4_{B}. Diffractive features 116 exhibit a stepwise variation in pitch d1, decreasing in each successive zone across zones Z10-Z12, and a constant grating vector k4_{A}. Diffractive features 116 exhibit a stepwise variation in grating vector along the y-axis dimension of the array, referred to as columns. That is, diffractive features 116 of each zone in a column comprise a set of parallel diffractive features having a common pitch d1, that extend in progressively different directions through angle ϕ. As shown, the angle of diffractive features 116 and their grating vectors k4_{A}, k4_{B}, k4_{C}, k4_{D} differ in zones Z1, Z4, Z7, and Z10, respectively. For example, while diffractive features 116 are linear in each respective zone, diffractive features 116 approximate a curved line in the direction of the y-axis dimension. Similarly, diffractive features 116 exhibit the stepwise variation in direction in the column including zones Z2, Z5, Z8, and Z11, and the column including zones Z3, Z6, Z9, and Z12.

It should be appreciated that grating vectors k4 for diffractive features 116 may increase in magnitude in the x-axis dimension as the pitch d1 decreases (i.e., k=2π/Λ). Thus, the magnitude of grating vector k4_{D} increases in stepwise fashion across zones Z1-Z3. Similarly, in some embodiments, grating vector k5_{C} increases in magnitude in stepwise fashion across zones Z4-Z6, grating vector k5_{B} increases in magnitude in stepwise fashion across zones Z7-Z9, and grating vector k5_{A} increases in magnitude in stepwise fashion across zones Z10-Z12.

Diffractive features 118 exhibit a stepwise variation in pitch d2 along the y-axis dimension of the array (i.e., the columns). Thus, pitch d2 in zone Z1 is greater than pitch d2 in zone Z4, which is greater than pitch d2 in zone Z7, which is greater than pitch d2 in zone Z10. In addition to its ordinary meaning to those in the art, the term “stepwise variation” is intended to describe that the common pitch d2 within each zone is constant within the zone, but in each successive zone along the y-axis dimension of the array the pitch changes, e.g., increases or decreases. Diffractive features 118 comprise the same curvature/grating orientation along the y-axis, namely, diffractive features 118 have the same grating vector k5_{A} across zones Z1, Z4, Z7, and Z10 (i.e., the angle of diffractive features 118 across zones Z1, Z4, Z7, and Z10 are the same, and thus diffractive features 118 across zones Z1, Z4, Z7, and Z10 are parallel to each other). This same behavior occurs with respect to diffractive features 118 across the y-axis throughout the array. Diffractive features 118 exhibit a stepwise variation in pitch d2, decreasing in each successive zone across zones Z2, Z5, Z8, and Z11, and a constant grating vector k5_{B}. Diffractive features 118 exhibit a stepwise variation in pitch d2, decreasing in each successive zone across zones Z3, Z6, Z9, and Z12, and a constant grating vector k5_{C}. Diffractive features 118 exhibit a stepwise variation in grating vector along the x-axis dimension of the array (i.e., the rows). That is, diffractive features 118 of each zone in a row comprises a set of parallel diffractive features d2, having the same pitch, that extend in progressively different directions through angle. As shown, the angle of diffractive features 118 and their grating vectors k5_{A}-k5_{C} differ in zones Z1-Z3, respectively. While diffractive features 118 are linear in each respective zone, diffractive features 118 approximate a curved line in the direction of the x-axis dimension. Similarly, diffractive features 118 exhibit the stepwise variation in direction in the row including zones Z4-Z6, the row including zones Z7-Z9, and the row including zones Z10-Z12.

It should be appreciated that grating vectors k5 for diffractive features 118 may increase in magnitude in the y-axis dimension as the pitch d2 decreases. Thus, the magnitude of grating vector k5_{A} increases in magnitude in stepwise fashion across zones Z1, Z4, Z7, and Z10. Similarly, in some embodiments, grating vector k5_{B} increases in magnitude in stepwise fashion across zones Z2, Z5, Z8, and Z11, and grating vector k5_{C} increases in magnitude in stepwise fashion across zones Z3, Z6, Z9, and Z12.

It should be appreciated that the vector contributions of either the curve (or approximated curve) and/or the chirp of diffractive features 116, 118 at any given point along out-coupling diffractive optic ODO independently create one-dimensional cylindrical optical power. When the vector contributions of the curve (or approximated curve) and the chirp of diffractive features 116, 118 are combined, two-dimensional optical power is introduced, that if properly balanced would create spherical optical power.

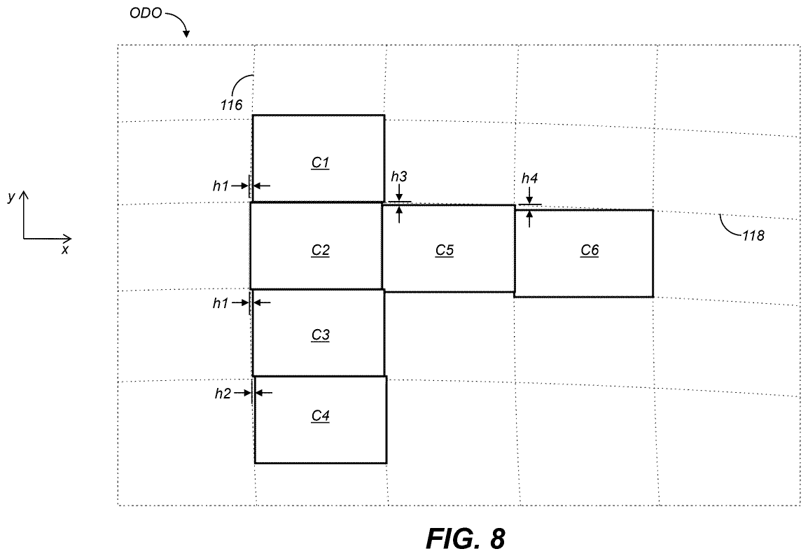

FIG. 8 shows, in simplified schematic form, a portion of an example embodiment of out-coupling diffractive optic ODO that is divided into a two-dimensional array of unit cells, which are arranged in a stepwise fashion to form or approximate curvilinear diffractive features. As shown in FIG. 8, and in some examples, the digital writing/etching process for generating surface relief gratings may be limited to linear motions, i.e., where the system is only able to produce surface relief patterns in the x-axis and y-axis dimensions, respectively. As such, and although only etch patterns in the x-axis and y-axis are possible, step-wise segments may be etched into out-coupling diffractive optic ODO that approximate a curved diffractive feature or approximate a diagonal diffractive feature, for example, a grating feature arranged along a direction between the x-axis and the y-axis. In an exemplary embodiment, each of the cells of the array are equal in size and shape (e.g., rectangular, square, etc.).

Unit cells C1-C4 are arranged in a column so as to form or approximate a curved diffractive feature 116. Cell C2 forms the apex of the curvature of diffractive feature 116. Cell C1 is arranged above cell C2 and is shifted in the direction of the x-axis dimension a distance h1 from cell C2. Similarly, Cell C3 is arranged below cell C2 and is shifted in the direction of the x-axis dimension a distance h1 from cell C2. Cell C4 is arranged below cell C3 and is shifted in the direction of the x-axis dimension a distance h2 from cell C3. In some embodiments, distance h2 is equal to distance h1. In some embodiments, distance h2 is not equal to distance h1. Cells C2 and C5-C6 are arranged in a row so as to form or approximate a curved diffractive feature 118. Cell C2 forms the apex of the curvature of diffractive feature 118. Cell C5 is arranged to the right of cell C2 and is shifted in the direction of the y-axis dimension a distance h3 from cell C2. Similarly, Cell C6 is arranged to the right of cell C5 and is shifted in the direction of the y-axis dimension a distance h4 from cell C5. In some embodiments, distance h4 is equal to distance h3. In some embodiments, distance h4 is not equal to distance h3. The arrangement shown in FIG. 8 is just one embodiment of how stepped cells can be used to form or approximate a curvilinear diffractive feature.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. An image light guide, comprising:
a substrate operable to propagate image-bearing light beams of a first wavelength range and a second wavelength range;
an in-coupling diffractive optic comprising a first input region and a second input region, the first input region operable to couple image-bearing light of the first wavelength range into the image light guide and the second input region operable to couple image-bearing light of the second wavelength range into the image light guide; and
an out-coupling diffractive optic comprising a first set of diffractive features and a second set of diffractive features, wherein the first set of diffractive features and the second set of diffractive features at least partially overlap within the out-coupling diffractive optic;
wherein the first and second set of diffractive features introduce an optical power to change a focusing distance of the first wavelength range and the second wavelength range of image-bearing light beams.

2. The image light guide as recited in claim 1, wherein the first set of diffractive features and the second set of diffractive features each introduce a different optical power.

3. The image light guide as recited in claim 1, further comprising a first turning optic operable to turn image-bearing light received from the first input region of the in-coupling diffractive optic toward the out-coupling diffractive optic.

4. The image light guide as recited in claim 3, wherein the image light guide comprises a second turning optic operable to turn image-bearing light received from the second input region of the in-coupling diffractive optic toward the out-coupling diffractive optic.

5. The image light guide as recited in claim 1, wherein each diffractive feature of the first set of diffractive features is curved.

6. The image light guide as recited in claim 5, wherein each diffractive feature of the second set of diffractive features is curved.

7. The image light guide as recited in claim 1, wherein the out-coupling diffractive optic includes a two-dimensional array of zones, wherein each zone comprises one or more of the first set of diffractive features and the second set of diffractive features, wherein each diffractive feature of the first set of diffractive features and the second set of diffractive features is linear, wherein each zone has a common pitch between each diffractive feature of the first and second sets of diffractive features, wherein the common pitch varies between successive zones in at least a first dimension of the two-dimensional array.

8. The image light guide as recited in claim 1, wherein the first set of diffractive features vary in pitch.

9. The image light guide as recited in claim 8, wherein the second set of diffractive features vary in pitch.

10. The image light guide as recited in claim 7, wherein the first set of diffractive features in the successive zones along the first dimension are oriented in a constant direction, and successive zones along a second dimension of the array are oriented in different directions in a manner that progressively varies in a stepwise manner between the successive zones along the second dimension.

11. The image light guide as recited in claim 10, wherein the second set of diffractive features in the successive zones along the first dimension are oriented in different directions in a manner that progressively varies in a stepwise manner between the successive zones along the first dimension, and successive zones along the second dimension are oriented in a constant direction.

12. The image light guide as recited in claim 1, wherein the first wavelength range of image-bearing light comprises red light.

13. The image light guide as recited in claim 1, wherein the second wavelength range of image-bearing light comprises blue light.

14. The image light guide as recited in claim 1, wherein the first set of diffractive features comprises a first pitch progression and the second set of diffractive features comprises a second pitch progression, the second pitch progression being equal to the first pitch progression.

15. The image light guide as recited in claim 1, wherein the first input region comprises a first pitch and the second input region comprises a second pitch.

16. The image light guide as recited in claim 1, wherein at least one of the first set of diffractive features and the second set of diffractive features comprise blazed, slanted, or hybrid grating features.

17. An image light guide system, comprising:
a frame;
an image source connected to the frame, wherein the image source is operable to emit image-bearing light of a first wavelength range and a second wavelength range; and
a waveguide connected to the frame, including:
an in-coupling diffractive optic comprising a first input region and a second input region, the first input region operable to couple image-bearing light of the first wavelength range into the waveguide and the second input region operable to couple image-bearing light of the second wavelength range into the waveguide; and
an out-coupling diffractive optic comprising a first set of diffractive features and a second set of diffractive features, wherein the first set of diffractive features and the second set of diffractive features at least partially overlap within the out-coupling diffractive optic and wherein the first set of diffractive features and the second set of diffractive features are operable to form a virtual image that is viewable from a viewer eyebox;
wherein at least the first set of diffractive features introduce an optical power that changes a focusing distance of the virtual image.

18. The image light guide system as recited in claim 17, wherein the first set of diffractive features and the second set of diffractive features introduce an optical power and change the focusing distance of the virtual image.

19. The image light guide system as recited in claim 17, wherein the image light guide comprises a first turning optic operable to turn image-bearing light received from the first input region of the in-coupling diffractive optic.

20. The image light guide system as recited in claim 19, wherein the image light guide comprises a second turning optic operable to turn image-bearing light received from the second input region of the in-coupling diffractive optic.

21. (canceled)
